(19) United States
(12) Patent Application Publication
(10) Pub. No.: US 2012/0073985 A1
(43) Pub. Date: Mar. 29, 2012

(54) METHOD FOR TREATING SLUDGE

(76) Inventors: Alexander Hahn, Rottenbach (DE); Hermann Schwarz, Wurburg (DE); Jochen Straub, Erlangen (DE); Manfred Waidhas, Nurnberg (DE)

(21) Appl. No.: 13/246,993

(22) Filed: Sep. 28, 2011

(30) Foreign Application Priority Data
Sep. 29, 2010 (DE) 10 2010 041 582.0

(51) Int. Cl. C02F 1/461; C02F 1/465; C02F 101/20

(52) U.S. Cl. 205/757; 205/742; 204/242; 204/272; 204/273

(57) ABSTRACT

In a method for treating sludge (1), at least two electrodes (2) are provided for generating an electric field. Water present in the biosludge is electrolyzed and OH° radicals (OH°) are generated at least in part.

### CROSS-REFERENCE TO RELATED APPLICATIONS

This application claims priority to German Patent Application No. 10 2010 041 582.0 filed Sep. 29, 2010, the contents of which is incorporated herein by reference in its entirety.

### TECHNICAL FIELD

The invention relates to a method for treating sludge.

### BACKGROUND

Sludge, in particular biosludge, accumulated in local authority and industrial wastewater treatment plants is nowadays almost exclusively processed thermally. The practice of processing it into manure is very much on the decline because of ever more stringent legislation. Furthermore, taking the accumulated sludge to landfill is associated with rising landfill costs. In addition, biosludge intended for landfill must not contain any active micro-organisms, so that in this case an additional disinfection stage is necessary.

For these reasons the thermal processing of biosludge at the production site or in central processing plants is becoming increasingly important. Hence the dewatering of the sludge is a particularly important procedural step during processing. By raising the level of dewatering of the sludge the calorific value can be increased on the one hand, while on the other hand improved dewatering results in a reduction in volume and weight. This is crucial when the sludge is transported to a central processing plant.

The accumulated biosludge is dewatered mechanically or mechanically/thermally. The prior art that can be cited concerning dewatering of biosludge and various methods for increasing dewatering of sludge includes the following publications: DE 10 2007 056 170 A1, EP 0 074 776 A2, DE 3 635 268 A1 and DE 9 312 198 U1.

It is known in principle that using powerful oxidizing agents can increase the dewatering of sludge. The oxidation results in the cell walls in the biosludge being attacked, allowing the enclosed water to escape. This is the basis for the improved dewatering of sludge. For example, DE 69 810 722 T2 describes a method for how wastewater sludge can be dewatered by introducing ozone gas into it.

However, none of the methods cited in the prior art describes a method which results in the dewatering of biosludge while simultaneously disinfecting it and in parallel to this is still suitable for separating any heavy metals out of bio-sludge.

### SUMMARY

According to various embodiments, a method can be provided which simultaneously in part ensures dewatering of biosludge, disinfection thereof and simultaneous separation of any heavy metals contained therein.

According to an embodiment, in a method for treating sludge, at least two electrodes are provided, by means of which an electric field is generated, wherein the electric field is embodied such that water present in the sludge is electrolyzed and OH° radicals are generated.

According to a further embodiment, the sludge may flow through the electric field. According to a further embodiment, heavy metals contained in the sludge can be reductively separated out at the negatively charged electrode. According to a further embodiment, a plurality of electrodes can be arranged one behind the other with an alternating polarization along a direction of flow of the sludge. According to a further embodiment, the electrodes arranged one behind the other reticularly may penetrate a region of flow of the sludge. According to a further embodiment, the electrodes can be arranged concentrically to one another along the direction of flow of the sludge. According to a further embodiment, the electrodes can be arranged as concentric tubes. According to a further embodiment, a spacing between two differently polarized electrodes may be less than 30 cm. According to a further embodiment, the sludge can be frothed with gas prior to contact with the electric field. According to a further embodiment, the electric field can be a pulsed field.

### BRIEF DESCRIPTION OF THE DRAWINGS

Further embodiments and further features emerge from the following drawings, in which features with the same designation and a different embodiment are provided with the same reference characters.

The drawings show:

FIG. 1 a schematic illustration of the electrochemical treatment of sludge, in particular biosludge,

FIG. 2 the arrangement of electrodes with alternating polarization in the form of grilles,

FIG. 3 the arrangement of electrodes in the direction of flow of the sludge in the form of cross-members,

FIG. 4 the arrangement of electrodes in the form of grids,

FIG. 5 the arrangement of electrodes in the form of concentric tubes and

FIG. 6 the arrangement of electrodes in the form of a plurality of concentric tubes with alternating polarization arranged one inside the other.

### DETAILED DESCRIPTION

In a method for treating sludge according to various embodiments at least two electrodes are provided, by means of which an electric field is generated. The electric field is designed such that water present in the sludge is electrolyzed and thereby OH° radicals are generated.

Sludge is here understood as aqueous solutions with solids which in particular contain organic and in particular biological solids. Such sludge can originate from local authority wastewater treatment plants or from industrial wastewater treatment plants. The term “sludge” in particular also refers to what is known as biosludge.

Thanks to the method according to various embodiments it is possible, by the electrochemical treatment of sludge, on the one hand to combine the dewatering characteristics with disinfection of the sludge and the facility for removing any heavy metals present. In the case of industrial wastewater sludge in particular it is especially important to release heavy metals from the sludge.

In electrochemical treatment of wastewater sludge the water present in the sludge is electrolyzed, with highly reactive OH° radicals thereby being produced. These act as a powerful oxidizing agent to improve the dewatering characteristics of the sludge. The disinfectant effect of the electrochemical treatment likewise results from the OH° radicals, in tandem with chlorine gas produced. Heavy metals contained in the sludge migrate to the cathode because of the electric field, where they are reductively separated out.

It is particularly expedient here if the sludge flows through the electric field, during which it can assume a linear motion, although a rotary motion in a circular basin may also be expedient.

Because of the high reactivity of the OH° radicals these have a very limited effective field in the vicinity of the electrode at which they form. Hence it is expedient to arrange a plurality of electrodes with alternating polarization one after the other along a direction of flow of the sludge.

The embodiment of the electrodes in a region of flow of the sludge can here assume various forms. It is generally described as reticular, which inter alia includes a grille shape, an array shape, grids or lattices or other networks, it being possible for the cross-section of the electrodes to assume different cross-sections, in particular affecting the flow of the biosludge.

In another embodiment the electrodes are arranged concentrically to one another along the direction of flow of the sludge. This can be done for example in the form of concentric tubes.

It has furthermore proved to be expedient to froth the sludge with gas before contact with the electric field. This frothing is in particular done during an agitation procedure. In particular air or oxygen can be used for frothing. The viscosity of the sludge is hereby advantageously increased, so that the flow properties of the sludge are improved in the region of the electrodes.

In principle it is expedient to apply a static electric field. However, it can also be advantageous, in particular to save energy, to apply a pulsed electric field. The pulsed electric field can be stronger with short pulse phases than a continuously applied field.

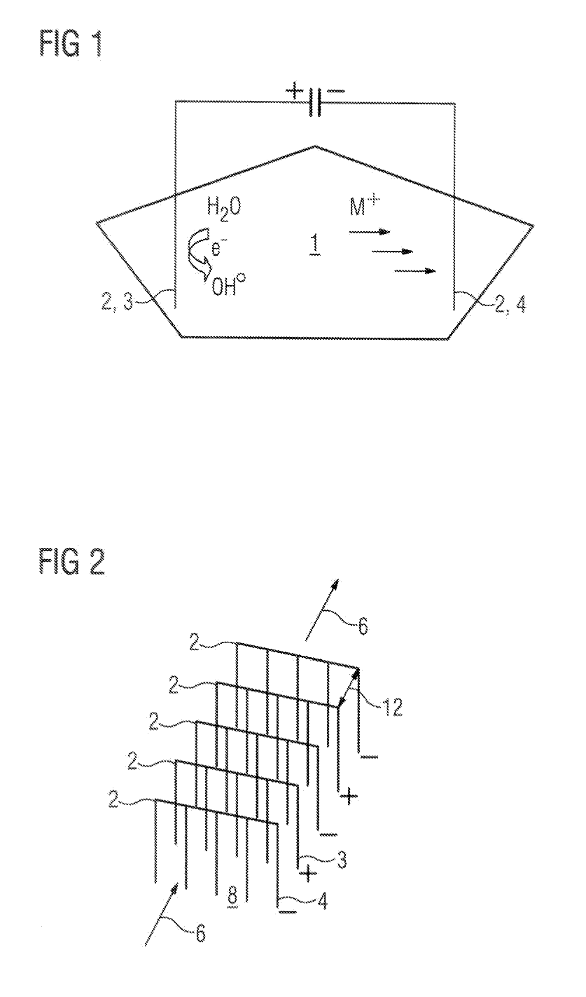

FIG. 1 shows a schematic illustration of the method for dewatering and disinfecting biosludge. Sludge 1, in particular biosludge, is hereby exposed to an electric field. The electric field is generated by two electrodes 2, one of these being a positively charged anode 3 while another electrode 2 is embodied in the form of a negatively charged cathode 4. When the electric field is applied it is generated between the anode 3 and the cathode 4. The water (H₂O) contained in the sludge is hereby electrolyzed in the electric field between the anode 3 and the cathode 4, whereby OH° radicals are produced. As a powerful oxidizing agent the OH° radicals help to improve the dewatering characteristics of the sludge, as they attack the cell walls of the biological components of the sludge, allowing the water contained therein to escape.

Furthermore any heavy metals (M⁺) present in the sludge can migrate to the cathode 4, where the metal ions (M⁺) are reduced and separated out to form an elementary metal. Furthermore the active micro-organisms in the sludge 1 are killed by the OH° radicals.

Thanks to this described method it is hence possible on the one hand to dewater sludge more thoroughly, which improves thermal processing, since as a result the calorific value of the sludge is increased. Furthermore, micro-organisms are killed, which is simultaneously a precondition for depositing the sludge in landfill. Sludge treated in this way can thus be thermally processed on the one hand, or on the other hand can be taken to landfill as necessary. Another reason this can be done is because heavy metals were simultaneously removed from the sludge.

FIGS. 2 to 6 show various expedient arrangements of the electrodes 2. Because of the high reactivity of the OH° radicals they are only effective in the comparatively close vicinity of the electrodes 2. Furthermore it is expedient not to space the electrodes 2, in other words the anode 3 and the cathode 4, further than 3000 cm²/ρ (Ω cm) apart, so that the operating voltage and the electric power thus to be applied does not become too high. In the case of a specific resistance of the medium to be treated of 100 Ω cm this means an expedient spacing of the electrodes of 30 cm. For this reason anode 3 and cathode 4 with alternating polarization are mounted alternately one behind the other in the form of grids or networks. This means in particular grille-shaped embodiments of the electrodes 2, as illustrated in FIG. 2. These grille-shaped electrodes 2 are positioned along a direction of flow 6 of the sludge 1 in the region of flow 8, whereby the polarization of the electrodes 2 in cathode 3 and anode 4 alternates.

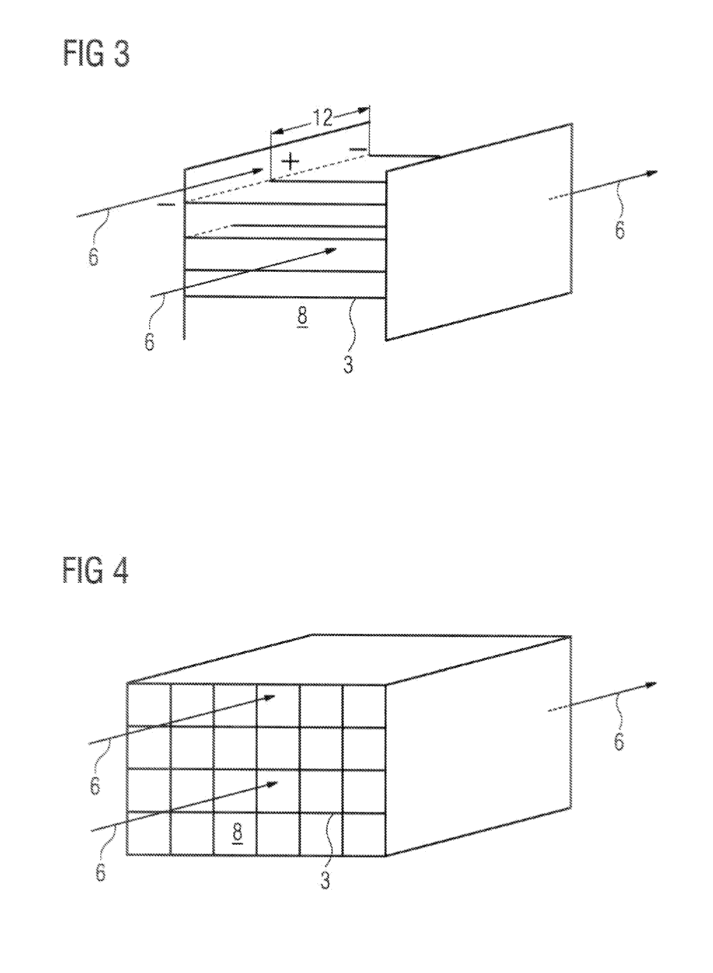

In accordance with FIG. 2, FIG. 3 shows an alternative embodiment of a reticular electrode combination 2, with cross-members here being arranged one behind the other and one above the other transversely to the direction of flow 6.

As in FIG. 3, FIG. 4 likewise shows a further embodiment of a reticular electrode arrangement. Here too, cathode 4 and anode 3 are arranged alternately one behind the other in the direction of flow 6. The network is here embodied in the form of a rectangular grid.

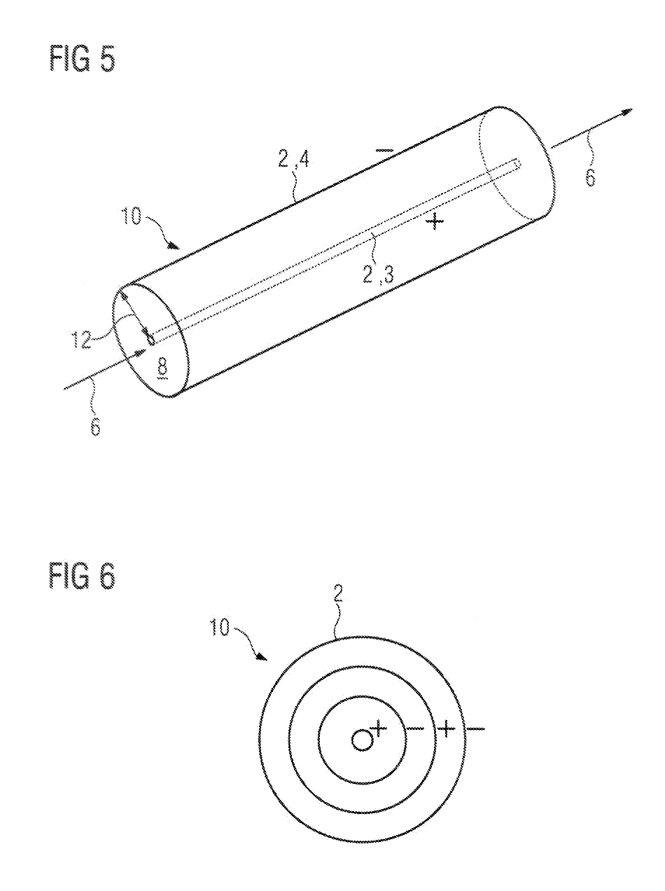

For all embodiments of the electrodes 2 according to FIGS. 2 to 4 it is the case that the cross-section of the electrodes 2 is adjusted in accordance with the electric field distribution and the flow characteristics of the sludge 1. Thus both a round cross-section and also a wedge-shaped or rectangular cross-section are expedient. As an alternative to the reticular embodiments of the electrodes as illustrated in FIGS. 2 to 4, a concentric electrode arrangement is described in FIGS. 5 and 6. This entails tubular electrodes 2 which are arranged concentrically one inside the other. Here for example an inner tube (or else a closed rod) is embodied in the form of a positively charged anode 3 and is arranged concentrically in a larger tube embodied in the form of a cathode 4. It may also be expedient, as is shown in cross-section in FIG. 6, to configure a plurality of concentric tubes as electrodes 2 one inside the other with alternating polarization.

Furthermore it has proved expedient to froth the sludge 1 with gas, in particular air or oxygen, in an agitation gasification procedure, to improve its flow characteristics and to increase its viscosity. As a result of the improved flow characteristics of the sludge 1 this results in simpler process management and less mechanical stress on the conveyor equipment.

The electric field applied may be a continuous electric field. However, in principle it has also proved expedient to create a pulsed electric field, since higher electric fields may be generated hereby with shorter pulse durations.

Coated titanium or niobium have in particular proved to be advantageous as the material for the anodes. Platinum and/or iridium oxide or ruthenium oxide are in particular used as a coating for titanium and niobium. Furthermore, boron-doped diamond coatings may be expedient. Stainless steels may likewise be used, if they have a chromium content of over 20% and a nickel content of likewise over 20%. Structural steel, stainless steel or carbon in graphite form have proved to be expedient for the cathode.

What is claimed is:

1. A method for treating sludge, wherein at least two electrodes are provided, the method comprising
generating an electric field by said two electrodes, wherein the electric field is embodied such that water present in the sludge is electrolyzed and OH° radicals are generated.

2. The method according to claim 1, wherein the sludge flows through the electric field.

3. The method according to claim 1, wherein heavy metals contained in the sludge are reductively separated out at the negatively charged electrode.

4. The method according to claim 1, wherein a plurality of electrodes is arranged one behind the other with an alternating polarization along a direction of flow of the sludge.

5. The method according to claim 4, wherein the electrodes arranged one behind the other reticularly penetrate a region of flow of the sludge.

6. The method according to claim 1, wherein the electrodes are arranged concentrically to one another along the direction of flow of the sludge.

7. The method according to claim 6, wherein the electrodes are arranged as concentric tubes.

8. The method according to claim 1, wherein a spacing between two differently polarized electrodes is less than 30 cm.

9. The method according to claim 1, wherein the sludge is frothed with gas prior to contact with the electric field.

10. The method according to claim 1, wherein the electric field is a pulsed field.

11. A system for treating sludge, comprising at least two electrodes, wherein the system is configured to generate an electric field by said two electrodes, wherein the electric field is embodied such that water present in the sludge is electrolyzed and OH° radicals are generated.

12. The system according to claim 11, wherein the sludge flows through the electric field.

13. The system according to claim 11, wherein heavy metals contained in the sludge are reductively separated out at the negatively charged electrode.

14. The system according to claim 11, wherein a plurality of electrodes is arranged one behind the other with an alternating polarization along a direction of flow of the sludge.

15. The system according to claim 14, wherein the electrodes arranged one behind the other reticularly penetrate a region of flow of the sludge.

16. The system according to claim 11, wherein the electrodes are arranged concentrically to one another along the direction of flow of the sludge.

17. The system according to claim 16, wherein the electrodes are arranged as concentric tubes.

18. The system according to claim 11, wherein a spacing between two differently polarized electrodes is less than 30 cm.

19. The system according to claim 11, wherein the sludge is frothed with gas prior to contact with the electric field.

20. The system according to claim 11, wherein the electric field is a pulsed field.
